(19) United States
(12) Patent Application Publication
(10) Pub. No.: US 2013/0246017 A1
(43) Pub. Date: Sep. 19, 2013

(54) COMPUTING PARAMETERS OF A PREDICTIVE MODEL

(71) Applicants: David Earl Heckerman, Santa Monica, CA (US); Jennifer Listgarten, Santa Monica, CA (US); Carl M. Kadie, Bellevue, WA (US); Omer Weissbrod, Savion (IL)

(72) Inventors: David Earl Heckerman, Santa Monica, CA (US); Jennifer Listgarten, Santa Monica, CA (US); Carl M. Kadie, Bellevue, WA (US); Omer Weissbrod, Savion (IL)

(73) Assignee: Microsoft Corporation, Redmond, WA (US)

(21) Appl. No.: 13/549,527

(22) Filed: Jul. 16, 2012

Related U.S. Application Data
(63) Continuation-in-part of application No. 13/419,439, filed on Mar. 14, 2012.
(60) Provisional application No. 61/652,635, filed on May 29, 2012.

(51) Int. Cl. G06F 17/10

(52) U.S. Cl. 703/2

(57) ABSTRACT

A computer-executable algorithm that estimates parameters of a predictive model in computation time of less than O(n²k²) when k<=n, is described herein, wherein n is a number of data items considered when estimating the parameters of the predictive model and k is a number of features of each data item considered when estimating the parameters of the predictive model. The parameters are estimated to maximize the probability of observing target values in the training data given the features considered in the training data.

### RELATED APPLICATIONS

This application is a continuation-in-part of U.S. patent application Ser. No. 13/419,439, filed on Mar. 14, 2012, and entitled “PREDICTING PHENOTYPES OF A LIVING BEING IN REAL-TIME”. This application also claims the benefit of U.S. Provisional Patent Application No. 61/652,635, filed on May 29, 2012, and entitled “COMPUTING PARAMETERS OF A PREDICTIVE MODEL”. The entireties of these applications are incorporated herein by reference.

### BACKGROUND

Computer-implemented predictive models have been employed in a variety of settings. For example, a predictive model that is trained to perform spam detection can receive an email and generate a prediction regarding whether such email is spam. Computer-implemented predictive models have also been employed to perform market-based prediction, where an investment or market condition is identified and a computer-implemented model trained to perform market prediction outputs an indication as to whether or not the investment, for example, is predicted to increase or decrease in value over some time range. Training these models to generate relatively accurate predictions requires employment of relative large amounts of data.

In general, training a predictive model is undertaken as follows: first, training data is collected, wherein the training data comprises a plurality of data items, and wherein each data item comprises a plurality of features. For example, if the data items represent emails, features of an email can include sender of the email, time that the email was sent, text of the email, whether or not the email includes an image, whether or not the email includes an attachment, etc. Accordingly, each email may have numerous features associated therewith, and each email may have values for the respective features. Further, in the training data, data items can be assigned respective values for an identified target. Continuing with the example pertaining to email, data items representative of emails can comprise respective values that are indicative of whether or not the respective emails are spam. Since each email is assigned a value indicative of whether the respective email is spam, and since each email comprises observed values for the respective plurality of features, by analyzing a relatively large collection of emails, weights can be learned that map the features to the target. The values of these weights are then set so as to cause the resultant predictive model to be optimized with respect to some metric.

Prediction is often probabilistic. That is, a prediction, given a set of features, often consists of a probability distribution over the target variable. There are currently several different types of algorithms that are commonly used to generate predictions. Such algorithms include L2 MAP and L1 MAP linear regression algorithms. In such approaches, priors on the weights that relate features (features of the data items used during training) to the target are employed to avoid overfitting. In these predictive settings, the weights are selected to be their maximum a posteriori (MAP) value given the training data. An L2 prior has a Gaussian distribution centered at zero, and an L1 prior has a Laplace (i.e, double exponential) distribution centered at 0. Both distributions are described by a free parameter (e.g. the variance of the Gaussian for the L2 prior and the half-life of the exponential for the L1 prior), sometimes called the regularization parameter. In both the L2 and L1 MAP standard approaches, the regularization parameter for the prior of each feature is the same (in other words, both models have a single parameter that needs to be learned over all features). Utilizing an empirical Bayes approach (that is, setting the value of the parameter from the data itself), the regularization parameter that yields optimal in-sample prediction (e.g., highest likelihood of the target data given the features considered in the training data) is learned.

Conventionally, utilizing an empirical Bayes approach to compute the regularization parameter of many predictive models (as well as other parameters of these predictive models) is a computationally expensive task. Specifically, algorithms that are currently employed to estimate parameters of Bayesian linear regression models have a computational time in big O notation of at least O(n²k²) (e.g. using cross-validation to set the parameters), where n is a number of data items in training data and k is a number of features considered during training. Thus, computation time for learning parameters of such a predictive model scales quadratically with both the number of data items considered during learning as well as the number of features considered during learning. Generally, the accuracy of a predictive model increases as a number of data items utilized to compute parameters of the predictive model increases. In conventional approaches to estimating the parameters in Bayesian linear regression, however, considering more data items results in a significant increase in computation time.

### SUMMARY

The following is a brief summary of subject matter that is described in greater detail herein. This summary is not intended to be limiting as to the scope of the claims.

Described herein are various technologies pertaining to estimating parameters of a predictive model through utilization of a computer-executable algorithm, wherein computation time of the computer-executable algorithm scales linearly with a number of data items considered when learning parameters of the predictive model are described herein. With more particularity, a regularization parameter, offset parameter, linear weights of covariates, and/or a residual variance parameter can be computed utilizing a computer-executable algorithm with a computation time of less than O(n²k²) in big O notation, where n is a number of data items considered when learning the parameter(s) and k is a number of features of the data items considered when learning the parameter(s). In an exemplary embodiment, the computer-executable algorithm can compute the aforementioned parameters in computation time of O(nk²), in big O notation, when k is less than or equal to n.

In an exemplary embodiment, the computer-executable algorithm can be an empirical Bayes algorithm that computes the parameter(s) such that a probability of predicting target values in training data is maximized given input features considered. In such an embodiment, the predictive model can be a Bayesian linear regression model or any of its mathematical equivalents, including but not limited to a Gaussian process regression model, a linear mixed model, and/or a Kriging model (with respective linear kernels).

The predictive model can be learned to perform predictions in any one of a variety of contexts. For example, the predictive model can be utilized to predict whether or not a received email is spam, whether or not a received email is a phishing attack, whether or not a user will select a particular search result responsive to issuing a query, whether a user will perform a particular action when employing a computing device, whether a user will perform a particular action when playing a video game, whether a person has a particular phenotype, amongst other applications. In an example, the predictive model can be trained to predict whether an incoming email is spam.

When computing parameters of the predictive model, training data is considered, wherein the training data comprises n emails, each email having k identified features and respective k observed values for those features. The aforementioned parameters are learned based upon the nk observed feature values for n emails. Through utilization of the empirical Bayes algorithm, parameters of the predictive model can be estimated in computing time that is linear with the number of emails in the training data (when there are fewer features than emails considered), where the parameters are learned such that in-sample predictive capabilities of the predictive model are optimized (e.g., the probability of predicting target values in the training data given the features considered is maximized). Subsequent to the parameters of the predictive model being computed, the model can be provided with the features of an email not included in the training data, and can output a prediction as to the specified target (output a probability distribution as to whether the email is spam).

Other aspects will be appreciated upon reading and understanding the attached figures and description.

### BRIEF DESCRIPTION OF THE DRAWINGS

FIG. 1 is a functional block diagram of an exemplary system that facilitates learning parameters of a Bayesian linear regression model utilizing an empirical Bayes approach in computing time that scales linearly with a number of data items considered in training data.

FIG. 2 illustrates exemplary training data that can be employed in connection with computing the parameters of the Bayesian linear regression model.

FIG. 3 is a functional block diagram of an exemplary system that facilitates identifying features of data items to consider when computing parameters of a Bayesian linear regression model.

FIG. 4 is a flow diagram that illustrates an exemplary methodology for computing parameters of a Bayesian linear regression model utilizing an empirical Bayes approach in computation time of less than O(n²k²), where n is a number of data items considered during learning and k is a number of features considered during learning.

FIG. 5 is a flow diagram that illustrates an exemplary methodology for predicting whether or not a particular data item corresponds to a specified target value through utilization of a Bayesian linear regression model.

FIG. 6 is an exemplary computing device.

### DETAILED DESCRIPTION

Various technologies pertaining to estimating parameters of a predictive model will now be described with reference to the drawings, where like reference numerals represent like elements throughout. In addition, several functional block diagrams of exemplary systems are illustrated and described herein for purposes of explanation; however, it is to be understood that functionality that is described as being carried out by certain system components may be performed by multiple components. Similarly, for instance, a component may be configured to perform functionality that is described as being carried out by multiple components. Additionally, as used herein, the term “exemplary” is intended to mean serving as an illustration or example of something, and is not intended to indicate a preference.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

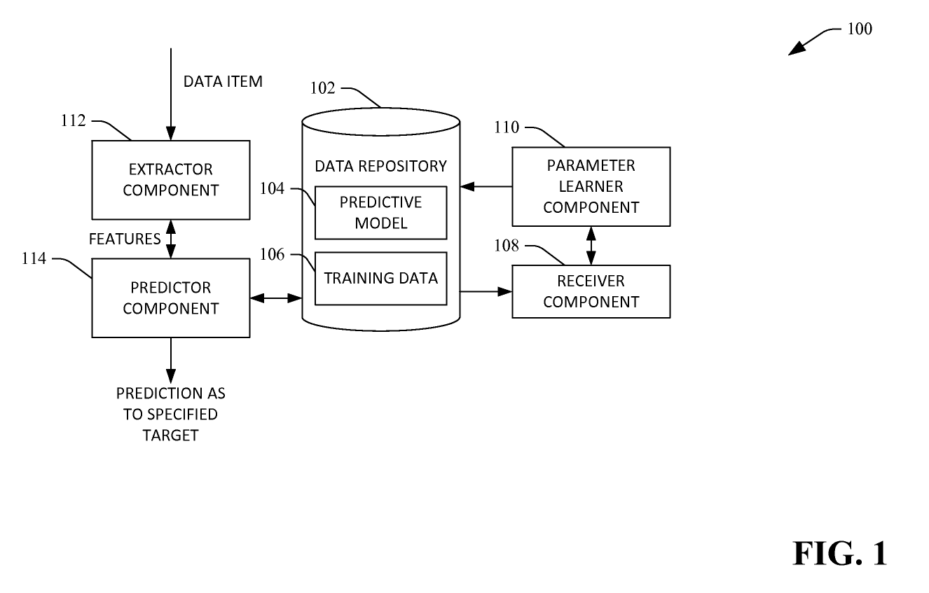

With reference now to FIG. 1, an exemplary system 100 that facilitates utilizing an empirical Bayes algorithm to compute parameters of a predictive model is illustrated, wherein the parameters maximize the probability of target values, and wherein the parameters are computed in computation time that is linear with a number of data items considered (when the number of data items is less than a number of features considered during computation of the parameters). The system 100 includes a data repository 102, which may be any suitable data storage device such as, but not limited to, computer-readable memory (e.g., RAM, ROM, EPROM, EEPROM, . . . ), a flash drive, a hard drive, or the like. The data repository 102 comprises a predictive model 104. In an exemplary embodiment, the predictive model 104 is a Bayesian linear regression model or any of its mathematical equivalents. Accordingly, the predictive model 104 may be referred to as a Gaussian process regression model, a linear mixed model, or a Kriging model, each with a linear kernel. The predictive model 104 comprises a plurality of parameters. Such parameters include, but are not limited to, a regularization parameter, an offset parameter, linear weights of covariates in the predictive model 104, residual variance, amongst others.

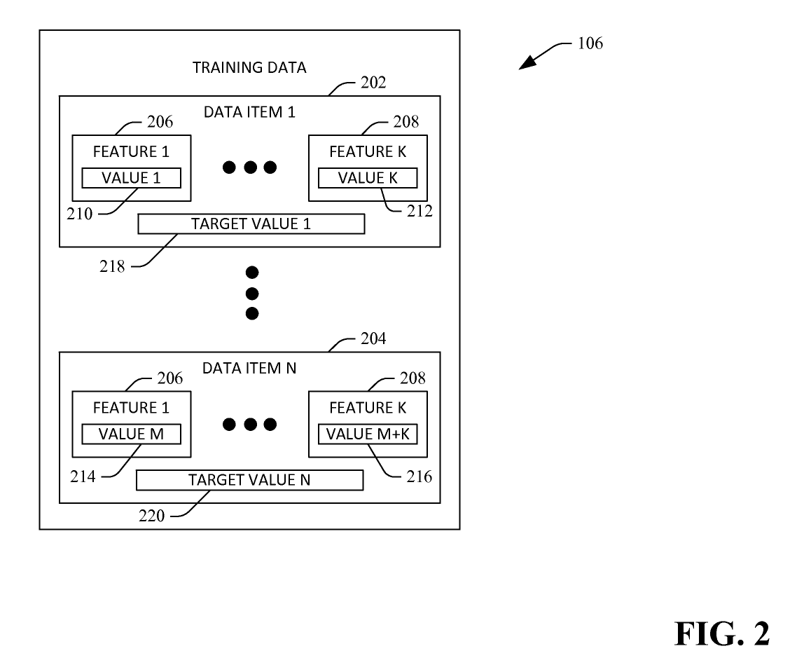

The data repository 102 further comprises training data 106 that is utilized in connection with computing the aforementioned parameters of the predictive model 104. Referring to FIG. 2, the training data 106 is shown in more detail. The training data 106 includes n computer-readable data items 202-204. Each of the data items 202-204 comprises k features with k respective observed values that are considered during the computation of the parameters of the predictive model 104. Accordingly, the first data item 202 includes a first feature 206 through a kth feature 208. The first feature 206 of the first data item 202 has a first observed value 210, and the kth feature 208 of the first data item 202 has a kth observed value 212. Similarly, the nth data item 204 comprises the first feature 206 through the kth feature 208, the first feature 206 of the nth data item 204 having an Mth observed value 214 and the kth feature 208 of the nth data item 204 having an M+kth observed value 216.

Each of the data items 202-204 also comprises a respective target value that is indicative of whether or not the respective data item corresponds to a specified target. Therefore, the first data item 202 has a first observed target value 218 and the nth data item 204 has an nth observed target value 220. In a non-limiting example, it may be desirable to learn a predictive model that generates predictions as to whether or not a received email is spam. Accordingly, the n data items 202-204 in the training data 106 can be representative of individual emails, and the features 206-208 of each of the data items 202-204 can represent particular features that correspond to emails. Exemplary features include, but are not limited to, sender of an email, time that an email was transmitted, whether or not the email includes certain text, whether or not the email includes an image, whether or not the email includes attachments, a number of attachments to the email, etc. The k observed feature values 210-212 for the first data item 202 can be indicative of observed values for the features 206-208 of the email represented by the first data item 202.

The observed target values 218-220 are observed values that indicate whether or not the respective emails represented by the n data items 202-204 are spam. Thus, for example, the first observed target value 218 for the first the data item 202 can indicate that a first email represented by the first data item 202 is a spam email. Similarity, the nth target observed value 220 for the nth data item 204 that is representative of an Nth email can indicate that the nth email is not spam.

In another example, the data items 202-204 in the training data 106 can represent emails, and the observed target values 218-220 can be indicative of whether the respective emails are phishing attacks. In yet another example, the data items 202-204 in the training data 106 can represent advertisements that are displayed on web pages (e.g. search results pages), the features 206-208 can be representative of features corresponding to such advertisements (e.g., text in the advertisements, time of display of the advertisements, queries used when the advertisements were displayed, search results shown together with the advertisements, . . . ), and the observed target values 218-220 can be indicative of whether or not the respective advertisements were selected by users.

In still yet another example, the data items 202-204 in the training data 106 can represent search results presented to users responsive to receipt of one or more queries. The features 206-208 can represent features corresponding to such search results (e.g., text included in the search results, domain name of the search results, anchor text corresponding to the search results, . . . ) and the observed target values 218-220 can be indicative of whether the respective search results were selected by users responsive to the users issuing the respective queries.

In another example, the data items 202-204 can represent actions taken by users on a computing device, the features 206-208 can represent features corresponding to such actions (e.g., previous actions undertaken, time actions were undertaken, applications executing on the computing device, . . . ) and the observed target values 218-220 can be indicative of whether the users undertook a specified subsequent action.

In yet another example, the data items 202-204 in the training data 106 can represent documents, the features 206-208 can represent features of the documents (e.g. words in the document, phrases in the document, . . . ), and the observed target values 218-220 can be indicative of whether or not the respective documents were assigned a particular classification (e.g., news, sports, . . . ).

In still yet another example, the data items 202-204 in the training data 106 can represent actions undertaken by players of a particular video game, the features 206-208 can represent features corresponding to such actions (identity of a game player, time of day when the game was played, previous actions undertaken by the game player, . . . ), and the observed target values 218-220 can be indicative of whether the respective game player undertook a specified subsequent action in the video game.

In another example, the data items 202-204 in the training data 106 can represent individuals, the features 206-208 can represent genetic markers of such individuals (e.g., SNPs), and the observed target values 218-220 can be indicative of whether the respective individuals have a specified phenotype. These examples of the various types of data items that can be considered when training the predictive model 104 have been set forth herein to emphasize that the predictive model 104 can be trained to perform a variety of prediction tasks (assuming a suitable amount of training data is available), and that the computer-executable algorithm used to learn parameters of the predictive model 104 can be employed regardless of the application for which the predictive model 104 is trained.

Returning to FIG. 1, the system 100 comprises a receiver component 108 that receives the training data 106 from the data repository 102. A parameter learner component 110 is in communication with the receiver component 108, and computes the aforementioned parameters of the predictive model 104 in computation time that is less than O(n²k²) (in big O notation), where n is the number of computer-readable items in the training data 106 and k is the number of observed feature values considered for each of the n data items. Further, it is understood that the parameter learner component 110 computes these parameters such that in-sample prediction capability of the predictive model 104 is maximized given the input features; in other words, the parameter learner component 110 computes the parameters such that the probability of observing the target values of data items in the training data 106 when considering the k observed feature values of each of the n data items is maximized. In an exemplary embodiment, the parameter learner component 110 can compute the parameters of the predictive model 104 in a computation time of O(nk²) when n is greater than k. Thus, the parameter learner component 110 can compute the parameters of the predictive model 104 in computation time that scales linearly with a number of data items in the training data 106 utilized to compute such parameters. Furthermore, the parameter learner component 110 can employ an empirical Bayes algorithm to compute the parameters in a computation time of O(nk²) such that the probability of the predictive model 104 predicting the observed target values 218-220 in the data items 202-204 is maximized when considering the k features 206-208. The algorithm employed by the parameter learner component 110 to compute the parameters of the predictive model 104 an order of n faster than conventional techniques will be described in detail below.

Subsequent to the predictive model 104 being trained such that the parameters are learned to maximize the likelihood of predicting the observed target values 218-224 of the data items 202-204 in the training data 106 when considering the k features 206-208, the predictive model 104 is deployable to generate a prediction as to whether a data item not included in the training data 106 corresponds to the specified target. Therefore, the system 100 can include an extractor component 112 that receives a data item not included in the training data 106 and extracts k observed values for the k features from such data item. A predictor component 114 is in communication with the extractor component 112, and receives the k observed feature values extracted from the received data item. While not shown as such, the predictor component 114 comprises or is in communication with the predictive model 104. The predictive model 104 (with the computed parameters) receives the k observed feature values for the data item and outputs a prediction as to whether or not the data item corresponds to the specified target. For example, the predictive model 104 can output a probability distribution over the possible values of the specified target.

As mentioned above, the predictor component 114 can generate predictions for data items that include the features upon which the predictor component 104 has been trained. Therefore, in non-limiting examples, the predictor component 114 can generate a prediction as to whether an email is spam, whether an email is a phishing attack, whether a document is to be assigned a specified classification, whether an advertisement will be clicked on by a user, whether a search result will be selected by a user, whether a user will undertake a specified action on a computing device, whether a user will undertake a particular in a video game, whether an individual has a particular phenotype, amongst a variety of other tasks.

With more detail pertaining to the predictor component 114 and the predictive model 104, an exemplary instantiation of such model 104 is described. In this example, the predictive model 104 is a Bayesian linear regression model, where the weights relating features to the specified target are mutually independent with a Normal prior having mean zero and variance σ_{g}² (the regularization parameter). This model leads to the following prediction algorithm: the predictive distribution for the specified target with features w_{*} and covariates vector x_{*} (which includes a bias term), given features, covariate, and observed target values for other data items, is a normal distribution whose mean and variance are given by

$$x * β + \frac{1}{{σ}_{e}^{2}} w * {A}^{- 1} {W}^{T} ( y - X β )$$

and w_{*}A⁻¹w_{*}^{T} respectively, where

$$A = \frac{1}{{σ}_{e}^{2}} {W}^{T} W + \frac{1}{{σ}_{g}^{2}} I ,$$

β is the covariate parameter vector, W is the n×k feature matrix of n data items in the training data 106, and the features used for prediction, X is the n×Q training covariate matrix for Q covariates, x_{*} is the 1×Q test covariate matrix, y is the observed target values of the data items in the training data 106, σₑ² is the residual variances, respectively, w_{*} is a 1×k vector containing the predictive features for a single data item, X^{T} denotes the matrix transpose of X, and I denotes the appropriately sized identity matrix.

Additional detail pertaining to the parameter learner component 110 is now provided. As discussed above, the parameter learner component 110 computes values for parameters (e.g., σ_{g}²) that maximize the probability of predicting observed target values in the training data 106 given the input features. Thus, the parameter learner component 110 can perform an empirical Bayes estimate, wherein σ_{g}² is chosen to maximize the likelihood of all of the observed target values in the training data 106, given the features and covariates.

The Bayesian linear regression model described above is equivalent to a linear mixed model with variance component weight σ_{g}². In either formulation, the log likelihood of the observed target values, y (dimension n×1), given fixed effects X (dimension n×d), which include, for instance, the covariates, and the column of ones corresponding to the bias (offset), can be written as follows:

LL(δ,σₑ²,σ_{g}²,β)=log N(y|Xβ;σ_{g}²K+σₑ²I), (1)

where N(r|m; Σ) denotes a normal distribution in variable r with mean m and covariance matrix Σ; K (dimension n×n) is the feature similarity matrix; I is the identity matrix; σₑ² (scalar) is the magnitude of the residual variance; σ_{g}² (scalar) is the magnitude of the variance component K; and β (dimension d×1) are the fixed-effect weights.

To estimate the parameters β, σ_{g}², and σₑ², and the log likelihood at those values, equation (1) can be factored. In particular, δ can be σₑ²/σ_{g}² and USU^{T} can be the spectral decomposition of K (where U^{T} denotes the transpose of U), so that equation (1) becomes as follows:

$$LL ( δ , {σ}_{g}^{2} , β ) = - \frac{1}{2} ( n log ( 2 {πσ}_{g}^{2} ) + log ( \vert U ( S + δ I ) {U}^{T} \vert ) + \frac{1}{{σ}_{g}^{2}} {( y - X β )}^{T} {( U ( S + δ I ) {U}^{T} )}^{- 1} ( y - X β ) ) , \qquad ( 2 )$$

where |K| denotes the determinant of matrix K. The determinant of the feature similarity matrix, |U(S+δI)U^{T}|, can be written as |S+δI|. The inverse of the feature similarity matrix can be rewritten as U(S+δI)⁻¹U^{T}. Thus, after additionally moving out U from the covariance term so that it now acts as a rotation matrix on the inputs (X) and targets (y), the following can be obtained:

$$LL ( δ , {σ}_{g}^{2} , β ) = - \frac{1}{2} ( n log ( 2 {πσ}_{g}^{2} ) + log ( S + δ I ) + \frac{1}{{σ}_{g}^{2}} {( ( {U}^{T} y ) - ( {U}^{T} X ) β )}^{T} {( S + δ I )}^{- 1} ( ( {U}^{T} y ) - ( {U}^{T} X ) β ) ) . \qquad ( 3 )$$

As the covariance matrix of the normal distribution is now a diagonal matrix S+δI, the log likelihood can be rewritten as the sum over n terms, yielding the following:

$$LL ( δ , {σ}_{g}^{2} , β ) = - \frac{1}{2} ( n log ( 2 {πσ}_{g}^{2} ) + {\sum }_{i = 1}^{n} log ( {[ S ]}_{ii} + δ ) + \frac{1}{{σ}_{g}^{2}} {\sum }_{i = 1}^{n} \frac{{( {[ {U}^{T} y ]}_{i} - {[ {U}^{T} x ]}_{i :} β )}^{2}}{{[ S ]}_{ii} + δ} ) , \qquad ( 4 )$$

where [U^{T}X]ᵢ: denotes the ith row of X. It can be noted that this expression is equal to the product of n univariate normal distributions on the rotated data, yielding the following linear regression equation:

LL(δ,σ_{g}²,β)=log Πᵢ₌₁ⁿN([U^{T}y]ᵢ|[U^{T}X]_{i:}β;σ_{g}²([S]ᵢᵢ)+δ) (5)

To determine the values of δ, σ_{g}² and β that maximize the log likelihood, equation (5) is first differentiated with respect to β, set to zero, and analytically solved for the maximum likelihood (ML) value of β(δ). This expression is then substituted in equation (5); the resulting expression is then differentiated with respect to σ_{g}², set to zero, and solved analytically for the ML value of a σ_{g}². Subsequently, the ML values of σ_{g}²(δ) and β(δ) can be plugged into equation (5) so that it is a function only of δ. Finally, this function of δ can be optimized using a one-dimensional numerical optimizer based on any suitable method.

Next the case where K is of low rank is considered; that is, the rank of K is less than or equal to k and less than or equal to n, the number of data items. This case will occur when the realized relationship matrix (RRM) is used for the similarity matrix and the number of (linearly independent) features used to estimate it, k, is smaller than n. K can be of low rank for other reasons: for example, by forcing some eigenvalues to zero.

In the complete spectral decomposition of K given by USU^{T}, S can be an n×n diagonal matrix containing the k nonzero eigenvalues on the top left of the diagonal, followed by n−k zeros on the bottom right. In addition, the n×n orthonormal matrix U can be written as [U₁, U₂], where U₁ (of dimension n×k) contains the eigenvectors corresponding to nonzero eigenvalues, and U₂ (of dimension n×n−k)) contains the eigenvectors corresponding to zero eigenvalues. Thus, K is given by USU^{T}=U₁S₁U₁^{T}+U₂S₂U₂^{T}. Furthermore, as S₂ is [0], K becomes U₁S₁U₁^{T}, the k-spectral decomposition of K, so-called because it contains only k eigenvectors and arises from taking the spectral decomposition of a matrix of rank k. The expression K+δ I appearing in the LMM likelihood, however, is always of full rank (because δ>0):

$$K + δ I = U ( S + δ I ) {U}^{T} = U [ \begin{matrix}{S}_{1} + δ I & 0 \\ 0 & δ I\end{matrix} ] {U}^{T} . \qquad ( 6 )$$

Therefore, it is not possible to ignore U₂ as it enters the expression for the log likelihood. Furthermore, directly computing the complete spectral decomposition does not exploit the low rank of K. Consequently, an algebraic trick involving the identity U₂U₂^{T}=I−U₁U₁^{T} can be used to rewrite the likelihood in terms not involving U₂. As a result, only the time and space complexity of computing U₁ rather than U is incurred.

Given the k-spectral decomposition of K, the maximum likelihood of the model 104 can be evaluated with time complexity O(nk) for the required rotations and O(C(n+k)) for the C evaluations of the log likelihood during the one-dimensional optimizations over δ. In general, the k-spectral decomposition can be computed by first constructing the genetic similarity matrix from k features at a time complexity of O(n² k) and space complexity of O(n²), and then finding its first k eigenvalues and eigenvectors at a time complexity of O(n² k). When the RRM is used, however, the k-spectral decomposition can be performed more efficiently by circumventing the construction of K because the singular vectors of the data matrix are the same as the eigenvectors of the RRM constructed from those data. In particular, the k-spectral decomposition of K can be obtained from the singular value decomposition of the n×k feature matrix directly, which is an O(nk²) operation. Therefore, the total time complexity of the predictive model 104 (low rank) using δ from the null model is O(nk²+nk+C(n+k)). When the target variable is binary, the relative predictive probability of the target being 1 (or 0) can be approximated using the LMM formulation. Namely, a value monotonic in the log relative predictive probability of the target being 1 for a given data item can be computed as the difference between (a) the log likelihood density (LL) for the target (given observed feature values and covariates) as computed by a linear mixed model algorithm with that data item's target set to 1 and (b) the LL for the target with that data item's target set to 0.

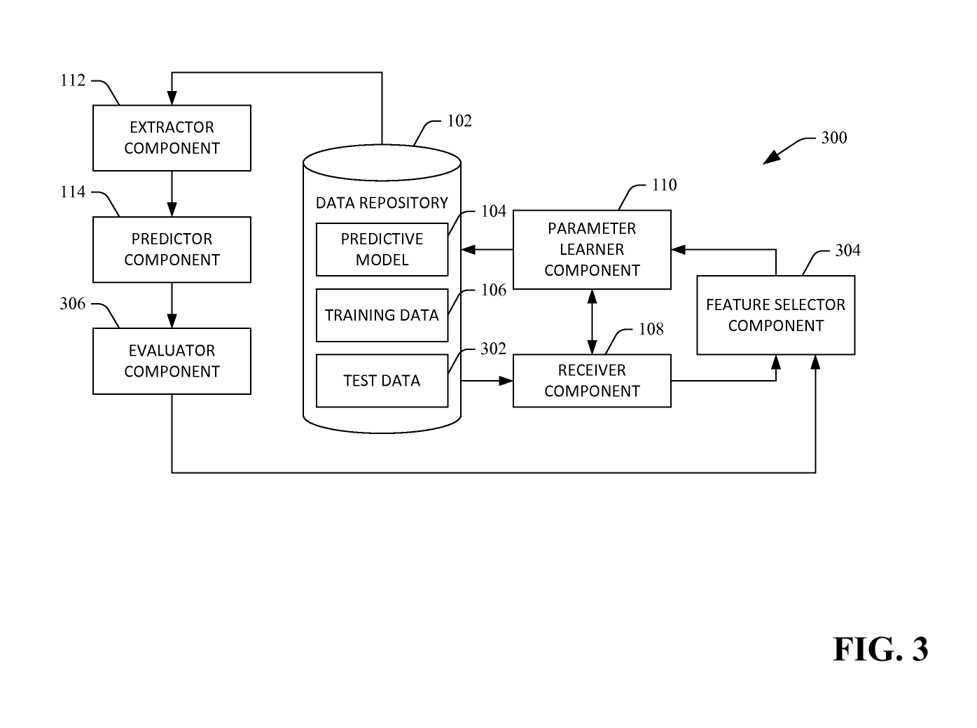

Now referring to FIG. 3, an exemplary system 300 that facilitates selecting which features to utilize when computing the parameters of the predictive model 104 as described above is illustrated. The system 300 comprises the data repository 102, which includes the predictive model 104 and the training data 106. The system 300 also includes the receiver component 108, the parameter learner component 110, the extractor component 112, and the predictor component 114, which operate as described above.

The data repository 102 further comprises test data 302, wherein the test data 302 comprises data items not included in the training data 106. Data items in the test data 302 comprise the k features in the data items of the training data 106 as well as respective observed target values.

The system 300 further comprises a feature selector component 304 that selects features of the data items in the training data 106 to consider during estimation of parameters of the predictive model 104. For instance, considering all features of data items in the training data 106 may not optimize predictive performance of the predictive model 104 when the parameters of such model 104 have been learned based upon all of such features. Instead, a selected subset of features, when employed to compute parameters of the predictive model 104, may correspond to optimal predictive performance when the predictive model 104 is deployed.

The feature selector component 304 can select features to consider utilizing any suitable technique. For example, the feature selector component 304 can univariately analyze features with respect to their ability to predict the specified target. Thus, the feature selector component 304 can individually analyze each feature of data items in the training data to ascertain their predictive relevance (when considered independently) to the specified target. The feature selector component 304 may then select the best q features (when considered independently) and provide such top q features to the parameter learner component 110. The parameter learner component 110 may then estimate parameters of the predictive model 104, as described above, utilizing the top q features identified during the univariate analysis.

The evaluator component 306 can then evaluate the predictive performance of the predictive model 104 utilizing the test data 302. For instance, the evaluator component 306 can employ cross validation to identify when predictive performance of the predictive model 104 is optimized. Therefore, the feature selector component 304 in combination with the evaluator component 306 can identify a set of features of the data items in the training data 106 for the parameter learner component 114 to employ when learning parameters of the predictive model 104, wherein learning the parameters of the predictive model 104 when utilizing such set of features results in a relatively high level of predictive accuracy. Furthermore, as discussed above, the parameter learner component 110 can learn the parameters of the predictive model 104 an order of n times faster than conventional approaches. Accordingly, a set of features that result in relatively high predictive accuracy can be identified much more quickly when compared to conventional techniques with no detriment (and probable improvement) in predictive accuracy of the predictive model 104.

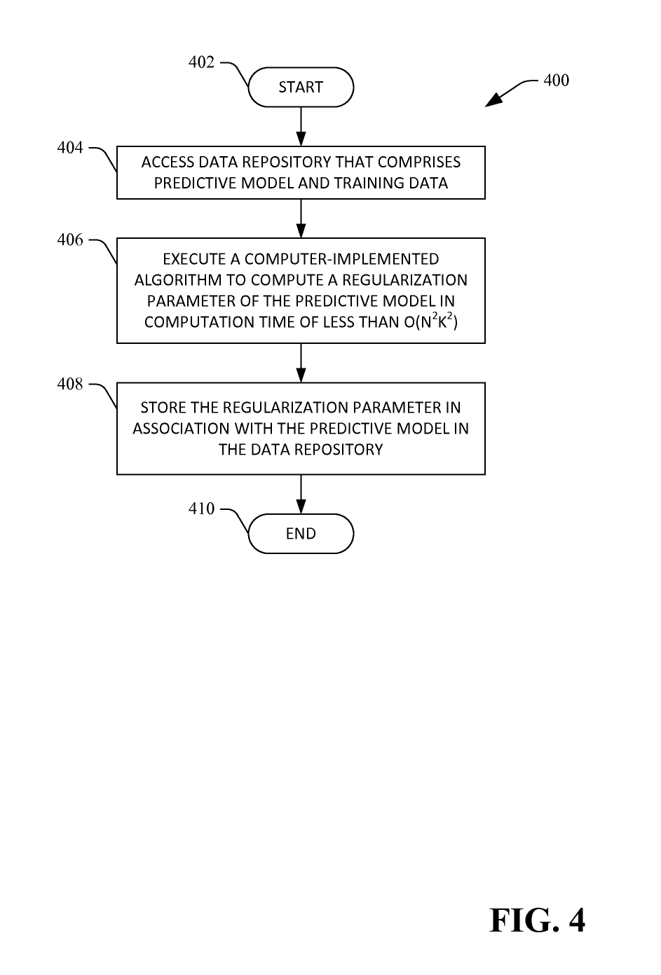

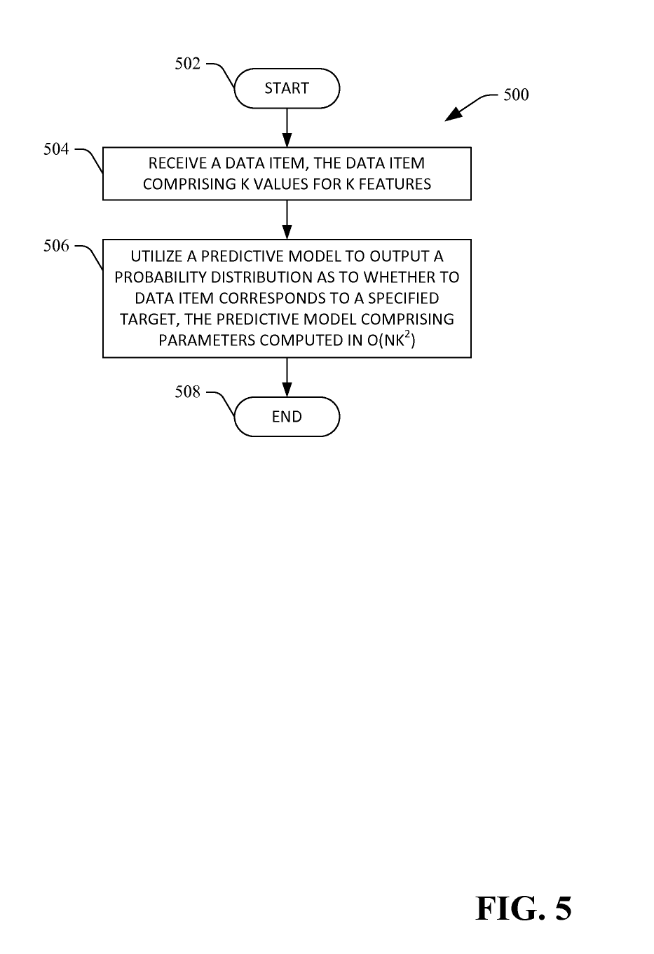

With reference now to FIGS. 4-5, various exemplary methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be any suitable computer-readable storage device, such as memory, hard drive, CD, DVD, flash drive, or the like. As used herein, the term “computer-readable medium” is not intended to encompass a propagated signal.

Referring solely to FIG. 4, an exemplary methodology 400 that facilitates computing parameters of a Bayesian linear regression model is illustrated. The methodology 400 starts at 402, and at 404 a data repository is accessed, wherein the data repository comprises a Bayesian linear regression model and training data. As indicated above, the Bayesian linear regression model comprises a plurality of parameters, wherein the plurality of parameters include a regularization parameter. Other parameters that are included in the Bayesian linear regression model include an offset parameter, linear weights of any covariates, and a residual variance. The training data includes n computer-readable data items. Each computer-readable data item in the training data comprises k observed values for respective k features of a respective computer-readable data item as well as a respective observed value for a specified target pertaining to the computer-readable item.

At 406, a computer-implemented empirical Bayes algorithm is executed to compute the regularization parameter of the Bayesian linear regression model such that the probability of the target data being identified given the consideration of the k observed feature values in the training data is maximized. The computer-implemented algorithm computes the regularization parameter in such fashion based at least in part upon the plurality of observed values for the respective plurality of features and respective observed values for the specified target in the training data. Furthermore, computation time of the computer-implemented empirical Bayes algorithm, in big O notation, is less than O(n²k²) when k is less than or equal to n. In an exemplary embodiment, the computation time of the empirical Bayes algorithm is O(nk²) when k is less than or equal to n.

At 408, at least the regularization parameter for the Bayesian linear regression model computed by way of the empirical Bayes algorithm is stored in the data repository. Subsequently, the Bayesian linear regression model can be employed to predict a value or determine a probability distribution over the possible values for the specified target variable responsive to receiving observed values for the k features for a computer-readable data item not included in the training data. The methodology 400 completes at 410.

Now referring to FIG. 5, an exemplary methodology 500 that facilitates outputting a probability distribution as to whether a computer-readable data item not included in training data corresponds to a specified target is illustrated. The methodology 500 starts at 502, and at 504 a computer-readable data item is received, wherein the computer-readable data item comprises k observed values for k features. Such k observed values, for instance, can be extracted from the computer-readable data item.

At 506, a predictive model is utilized to output a probability distribution as to whether the data item corresponds to a specified target, wherein the parameters of the predictive model have been employed utilizing the empirical Bayes algorithm described above. The methodology 500 completes at 508.

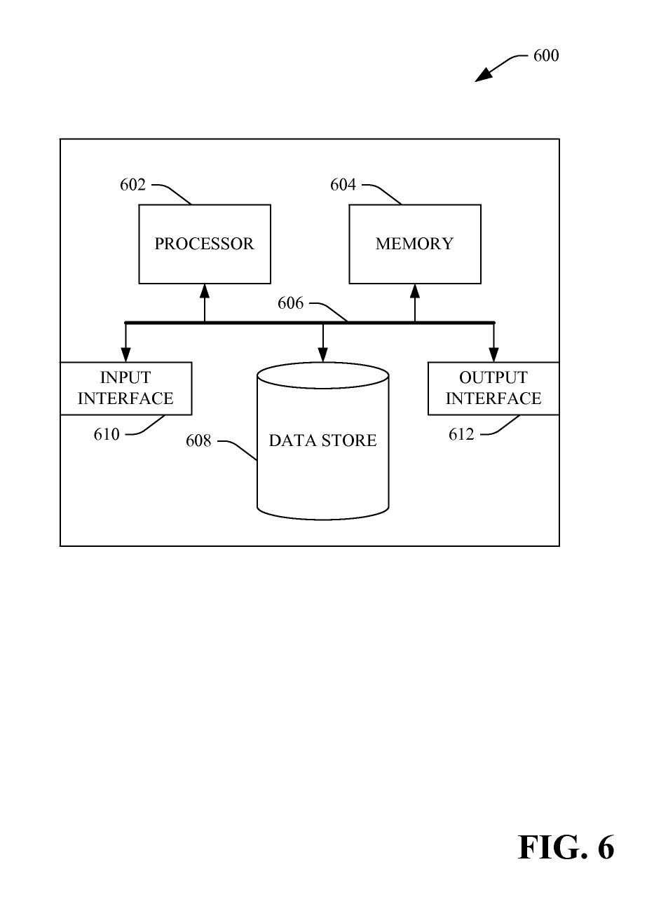

Now referring to FIG. 6, a high-level illustration of an exemplary computing device 600 that can be used in accordance with the systems and methodologies disclosed herein is illustrated. For instance, the computing device 600 may be used in a system that supports estimating parameters of a predictive model. In another example, at least a portion of the computing device 600 may be used in a system that supports outputting predictions as to whether or not a received data item corresponds to a specified target. The computing device 600 includes at least one processor 602 that executes instructions that are stored in a memory 604. The memory 604 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 602 may access the memory 604 by way of a system bus 606. In addition to storing executable instructions, the memory 604 may also store data items, observed feature values, observed target values, etc.

The computing device 600 additionally includes a data store 608 that is accessible by the processor 602 by way of the system bus 606. The data store may be or include any suitable computer-readable storage, including a hard disk, memory, etc. The data store 608 may include executable instructions, data items, observed feature values, observed target values, etc. The computing device 600 also includes an input interface 610 that allows external devices to communicate with the computing device 600. For instance, the input interface 610 may be used to receive instructions from an external computer device, from a user, etc. The computing device 600 also includes an output interface 612 that interfaces the computing device 600 with one or more external devices. For example, the computing device 600 may display text, images, etc. by way of the output interface 612.

Additionally, while illustrated as a single system, it is to be understood that the computing device 600 may be a distributed system. Thus, for instance, several devices may be in communication by way of a network connection and may collectively perform tasks described as being performed by the computing device 600.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method executed by a processor of a computing device, the method comprising:
accessing a data repository, the data repository comprising:
a computer-implemented Bayesian linear regression model, wherein the Bayesian linear regression model comprises a plurality of parameters, and wherein the plurality of parameters comprise a regularization parameter; and
training data, the training data comprising n computer-readable items, each computer-readable item in the training data comprising:
k observed values for respective k features of a respective computer-readable item; and
a respective observed value for a specified target pertaining to the respective computer-readable item;
executing a computer-implemented algorithm to compute the regularization parameter of the Bayesian linear regression model, wherein the computer-implemented algorithm computes the regularization parameter based at least in part upon the plurality of observed values for the respective plurality of features and respective observed values for the specified target, wherein the computer-implemented algorithm computes the regularization parameter such that an overall likelihood of correctly identifying the specified target across the n computer-readable items when considering the k features is maximized, and wherein computational time of the computer-implemented algorithm, in big O notation, is less than O(n²k²) when k is less than or equal to n; and
storing the regularization parameter for the Bayesian linear regression model computed by way of the computer-implemented algorithm in the data repository, wherein the Bayesian linear regression model is configured to predict a value or determine a probability distribution for the specified target variable responsive to receiving values for the k features for a received computer-readable data item.

2. The method of claim 1, wherein the running time of the computer-implemented algorithm, in big O notation O, is O(n k²) when k is less than or equal to n.

3. The method of claim 1, wherein the n computer-readable data items are representative of individuals, wherein the k observed values for each respective individual are representative of genetic traits of the respective individual, and wherein the specified target is an indication as to whether or not the respective individual has a particular phenotype.

4. The method of claim 1, wherein the n computer-readable items are representative of n emails, wherein the k observed values for each respective email are representative of k features of the respective email, and wherein the specified target is an indication as to whether or not the respective email is a spam email.

5. The method of claim 4, further comprising:
receiving a first computer-readable item, the first computer-readable item being an email;
extracting k observed values for the k features of the email;
providing the k observed values for the k features of the email to the Bayesian linear regression model; and
utilizing the Bayesian linear regression model with the computed regularization parameter to output a value or probability distribution that is indicative of whether the email is a spam email.

6. The method of claim 1, wherein the n computer-readable items are representative of n emails, wherein the k observed values for each respective email are representative of k features of the respective email, and wherein the specified target is an indication as to whether or not the respective email is a phishing attack.

7. The method of claim 6, further comprising:
receiving a first computer-readable item, the first computer-readable item being an email;
extracting k observed values for the k features of the email;
providing the k observed values for the k features of the email to the Bayesian linear regression model; and
utilizing the Bayesian linear regression model with the computed regularization parameter to output a value or probability distribution that is indicative of whether the email is a phishing attack.

8. The method of claim 1, wherein the n computer-readable items are representative of n documents, wherein the k observed values for each respective document are representative of k features of the respective document, and wherein the specified target is an indication as to whether or not the respective document is to be assigned a particular classification.

9. The method of claim 8, further comprising:
receiving a first computer-readable item, the first computer-readable item being a document comprising text;
extracting k observed values for the k features of the document;
providing the k observed values for the k features of the document to the Bayesian linear regression model; and
utilizing the Bayesian linear regression model with the computed regularization parameter to output a value or probability distribution that is indicative of whether the email corresponds to the particular classification.

10. The method of claim 1, wherein the n computer-readable items are representative of n documents, wherein the k observed values for each respective document are representative of k features of the respect document, and wherein the specified target is an indication as to whether or not a user will select a document.

11. The method of claim 10, further comprising:
receiving a first computer-readable item, the first computer-readable item being a document;
extracting k observed values for the k features of the document;
providing the k observed values for the k features of the document to the Bayesian linear regression model; and
utilizing the Bayesian linear regression model with the computed regularization parameter to output a value or probability distribution that is indicative of whether a user will select the document.

12. The method of claim 11, wherein the document is one of an advertisement or a search result.

13. The method of claim 1, wherein the n computer-readable items are representative of n actions of a user of a computing apparatus, wherein the k observed values for each respective action are representative of k features corresponding to the respective action, and wherein the specified target is an indication as to whether or not the user of the computing apparatus will subsequently perform a particular action.

14. The method of claim 13, further comprising:
receiving a first computer-readable item, the first computer-readable item being representative of an action undertaken by the user of the computing apparatus;
determining k observed values for the k features of the action;
providing the k observed values for the k features of the action to the Bayesian linear regression model; and
utilizing the Bayesian linear regression model with the computed regularization parameter to output a value or probability distribution that is indicative of whether the user is predicted to perform a second action subsequent to undertaking the first action.

15. A system, comprising:
a processor; and
a memory, the memory comprising a plurality of components that are executed by the processor, the components comprising:
a receiver component that receives training data from a data repository accessible by the processor, the training data comprising:
n computer-readable items, wherein each computer-readable item in the plurality of computer-readable items comprises:
k observed values for respective k features of the respective computer-readable item; and
a target observed value for a specified target that corresponds to the respective computer-readable item; and
a parameter learner component that computes a plurality of parameters of a predictive model responsive to the receiver component receiving the training data from the data repository, the plurality of parameters comprising at least one of a regularization parameter, an offset parameter, a linear weight of a covariate, or a residual variance, the parameter learner component computing the plurality of parameters of the predictive model with a computation time that is less than O(n²k²), wherein the parameter learner component computes the plurality of parameters such that a probability of observing target values for the n computer-readable items is maximized over the n computer-readable items given the kn observed feature values, wherein the parameter learner component causes the plurality of parameters to be stored in the data repository as a portion of the predictive model, and wherein the predictive model is configured to output a probability distribution that is indicative of whether a computer-readable item outside of the training data corresponds to the specified target.

16. The system of claim 15, wherein parameter learner component utilizes an empirical Bayes estimate to compute the plurality of parameters of the predictive model.

17. The system of claim 15, further comprising:
an extractor component that receives a computer-readable data item not included in the training data and extracts k observed values for the k features of the computer-readable data item; and
a predictor component that receives the k observed values for the k features of the computer-readable data item and outputs a probability distribution that is indicative of whether the computer-readable data item corresponds to the specified target, wherein the predictor component comprises the predictive model.

18. The system of claim 15, wherein the predictive model is a Bayesian linear regression model.

19. The system of claim 15, wherein the parameter learner component computes the plurality of parameters with a computation time of O(nk²) when k<=n.

20. A computer-readable medium comprising instructions that, when executed by a processor, cause the processor to perform acts comprising:
receiving training data, the training data comprising:
n computer-readable data items;
kn feature observed values, wherein each computer-readable data item comprises k features and respective k observed values for the k features; and
n observed target values for the respective n computer-readable data items, each observed target value corresponding to a desired target of prediction;
computing, via empirical Bayes estimation, a plurality of parameters for a Bayesian linear regression model based at least in part upon the kn observed feature values and the n observed target values, wherein the plurality of parameters comprises a regularization parameter, and wherein the plurality of parameters are computed at a computation time, in big O notation, of O(nk²).
